(19) United States
(12) Patent Application Publication
(10) Pub. No.: US 2006/0078107 A1
(43) Pub. Date: Apr. 13, 2006

(54) Diffused data encryption/decryption processing method

(76) Inventor: Chiou-Haun Lee, Taichung City (TW)

Correspondence Address: CHARLES E. BAXLEY, ESQ., 90 JOHN STREET, THIRD FLOOR, NEW YORK, NY, 10038, US

(21) Appl. No.: 10/963,014

(22) Filed: Oct. 12, 2004

(51) Int. Cl. H04L 9/28

(52) U.S. Cl. 380/28

(57) ABSTRACT

The present invention discloses a diffused data encryption/decryption processing method, which comprises a plaintext, being at least a 2D matrix; and a password, being at least a 2D matrix; such that the password determines the starting point of the diffusion, the length of the diffusion, the cycle of diffusion, the number of encrypted diffusions and the number of decrypted diffusions to perform the diffusion computation of the plaintext as to achieve the purpose of processing the encryption and decryption.

### BACKGROUND OF THE INVENTION

1. Field of the Invention

The present invention relates to a data encryption/decryption processing method, more particularly to a method of encrypting and decrypting data directly by an n-dimensional diffused data displacement, exclusive or operation and continuous diffused iteration operation.

2. Description of the Related Art

A prior-art data encryption/decryption processing method combines a plaintext with a password to produce a ciphertext by performing iterated computations such as a displacement, an exclusive or operation and a transformation with a plaintext, a password and a bit-conversion table. The ciphertext can be converted back into the plaintext by computing the ciphertext and password with the same method. If other users do not have the original password, then the ciphertext cannot be converted back into the plaintext, and it thus can achieve the purpose of protecting confidential information. Basically, the prior art performs an one-dimensional logical computation and a 2D transformation on the plaintext and the password to produce an unrelated processing between the plaintext and the ciphertext. For processing the same data, an one-dimensional computation takes longer time than an n-dimensional computation, and the bit-conversion table makes it difficult to flexibly adjust the length of a processing block.

### SUMMARY OF THE INVENTION

In view of the foregoing shortcomings of the prior art, the inventor of the present invention focused on the problems to start finding a way for the improvement and overcome the shortcomings in hope of finding a feasible solution, and conducted extensive researches and experiments and finally invented the diffused data encryption/decryption processing method in accordance with the present invention.

Therefore it is the primary objective of the present invention to replace the traditional conversion table by the iterated diffusions of the plaintext and password, not only can simplify the codes of the required program and perform the encryption and decryption processing for the 64/100/144/196/256-bit data or higher, but also can perform a chain block coding (CBC) after dividing the data into several blocks to encrypt several blocks simultaneously or encrypt continuous blocks in order to enhance the encryption level and reliability as well as shorten the processing time for the full text.

The technical measure taken by the present invention is described below:

A diffused data encryption/decryption processing method, comprises:
a plaintext, being at least a 2D matrix; and
a password, being at least a 2D matrix;
such that the password determines the starting point of the diffusion, the length of the diffusion, the cycle of diffusion, the number of encrypted diffusions and the number of decrypted diffusions to perform the diffusion computation of the plaintext as to achieve the purpose of processing the encryption and decryption.

### BRIEF DESCRIPTION OF THE DRAWINGS

The above objects, features and advantages of the present invention will become apparent from the following detailed description taken with the accompanying drawing. However, these drawings are provided for reference and illustration and not intended to act as a limitation to the present invention.

FIG. 1A is a flow chart of performing the encrypted diffusion computation according to the present invention.

FIG. 1B is a flow chart of performing the decrypted diffusion computation according to the present invention.

FIG. 1C is a table showing the corresponding positions between the plaintext and the password according to the present invention.

FIG. 2A is another flow chart of performing the encrypted diffusion computation according to the present invention.

FIG. 2B is another flow chart of performing the decrypted diffusion computation according to the present invention.

FIG. 3A is a flow chart of performing the encrypted diffusion computation of the whole text according to the present invention.

FIG. 3B is a flow chart of performing the decrypted diffusion computation of the whole text according to the present invention.

FIG. 4A is a flow chart of performing the encrypted diffusion computation of another whole text according to the present invention.

FIG. 4B is a flow chart of performing the decrypted diffusion computation of another whole text according to the present invention.

FIG. 5A is a flow chart of performing the encrypted diffusion computation of another further whole text according to the present invention.

FIG. 5B is a flow chart of performing the decrypted diffusion computation of another further whole text according to the present invention.

FIG. 6A is a flow chart of performing the 3-dimentional encrypted diffusion computation of another whole text according to the present invention.

FIG. 6B is a flow chart of performing the 3-dimensional decrypted diffusion computation of another whole text according to the present invention.

### DETAILED DESCRIPTION OF THE PREFERRED EMBODIMENTS

The diffused data encryption and decryption processing method according to the present invention comprises:

a plaintext, being at least a 2-dimensional matrix in binary digits; for example, the 8-character plaintext “smoother” is represented by the ASCII code “73 6D 6F 6F 74 68 65 72” and its corresponding binary 2-dimensional matrix is given in Table 1-1 below:

TABLE 1-1
ASCII

| 73 | 6D | 6F | 6F | 74 | 68 | 65 | 72 |
|---|---|---|---|---|---|---|---|
| 1 | 1 | 1 | 1 | 0 | 0 | 1 | 0 |
| 1 | 0 | 1 | 1 | 0 | 0 | 0 | 1 |
| 0 | 1 | 1 | 1 | 1 | 0 | 1 | 0 |
| 0 | 1 | 1 | 1 | 0 | 1 | 0 | 0 |
| 1 | 0 | 0 | 0 | 1 | 0 | 0 | 1 |
| 1 | 1 | 1 | 1 | 1 | 1 | 1 | 1 |
| 1 | 1 | 1 | 1 | 1 | 1 | 1 | 1 |
| 0 | 0 | 0 | 0 | 0 | 0 | 0 | 0 |

a password, being at least a 2-dimensional matrix in binary digits; for example, an eight-character password “Y ourlips” is represented by the ASCII code “59 6F 75 72 6C 69 70 73” and its corresponding binary 2-dimensional matrix is given in Table 1-2 below:

TABLE 1-2
ASCII

| 59 | 6F | 75 | 72 | 6C | 69 | 70 | 73 |
|---|---|---|---|---|---|---|---|
| 1 | 1 | 1 | 0 | 0 | 1 | 0 | 1 |
| 0 | 1 | 0 | 1 | 0 | 0 | 0 | 1 |
| 0 | 1 | 1 | 0 | 1 | 0 | 0 | 0 |
| 1 | 1 | 0 | 0 | 1 | 1 | 0 | 0 |
| 1 | 0 | 1 | 1 | 0 | 0 | 1 | 1 |
| 0 | 1 | 1 | 1 | 1 | 1 | 1 | 1 |
| 1 | 1 | 1 | 1 | 1 | 1 | 1 | 1 |
| 0 | 0 | 0 | 0 | 0 | 0 | 0 | 0 |

To make it easier for our examiner to understand the objective of the invention, its structure, innovative features, and performance, we use a preferred embodiment together with the attached drawings for the detailed description of the diffusion method, symbols and definition.

The diffusion method comprises a diffused area, and such area comprises a starting point of the diffusion being used as a diffusion center to diffuse data outward in sequence, and the diffused directions include a vertical direction and a horizontal direction. An exclusive or operation is performed on the value in the diffused area receiving a diffused value transmitted from the vertical and horizontal areas to produce a new value to be filled into the area, and such new value is used to continue the diffused value outward until the diffusion computation for the whole area is completed.

Symbols and Definition of Diffusion are given below:
A(i,j): Matrix A uses Point (i, j) as the starting point to diffuse data in sequence outward.

$$A ( {i}^{t} , j ) \text{:}$$

Matrix A uses Point (i, j) as the starting point to repeat the diffusion for t times.

$$\begin{matrix}For example , ( a ) A ( {i}^{2} , j ) = A ( i , j ) ( i , j ) \\ ( b ) A ( {i}^{1} , j ) = A ( i , j ) \\ ( c ) A ( {i}^{0} , j ) = A\end{matrix}$$

$${A ( i , j )}_{p} \text{:}$$

Matrix A uses Point (i, j) as the starting point, and p as the diffused length of successive positions.

$$\begin{matrix}For example , ( a ) {A ( i , j )}_{2} = A ( i , j ) ( i + 1 , j ) \\ ( b ) {A ( i , j )}_{1} = A ( i , j ) \\ ( c ) {A ( i , j )}_{0} = A\end{matrix}$$

$$A ( {{i}^{t}}_{p} , j ) \text{:}$$

Matrix A uses Point (i, j) as the starting point and p as the diffused length of successive positions to repeat the diffusion for t times.

$$\begin{matrix}For example , ( a ) A ( {{i}^{2}}_{2} , j ) = A ( i , j ) ( i + 1 , j ) ( i , j ) ( i + 1 , j ) \\ ( b ) A ( {{i}^{2}}_{3} , j ) = A ( i , j ) ( i + 1 , j ) ( i + 2 , j ) ( i , j ) ( i + 1 , j ) ( i + 2 , j )\end{matrix}$$

$$b ( {i}^{t} , j ) \text{:}$$

Zero matrix uses Point (i, j) as the starting point to repeat the diffusion for t times.

$$\begin{matrix}For example , ( a ) b ( {i}^{1} , j ) = b ( i , j ) \\ ( b ) b ( {i}^{0} , j ) = b = 0\end{matrix}$$

$$b ( {i}_{p} , j ) \text{:}$$

Zero matrix Point (i, j) as the starting point and p as the diffused length of successive positions.

$$\begin{matrix}For example , b {( i , j )}_{1} = b ( i , j ) & ( a ) \\ b {( i , j )}_{0} = b = 0 & ( b )\end{matrix}$$

After the matrix is diffused successively for r times, a cycle is produced, and Matrix A uses Point (i, j) as the starting point and p as the diffused length for successive positions to recover Matrix A after being diffused for r times. The equation is given below:

For the equation of the number of times of the diffusion:

$$p > 1 \text{:} A ( {{i}^{t}}_{p} , j ) = A \to b ( {{i}^{t}}_{p} , j ) = 0$$

$$p = 1 \text{:} A ( {i}^{t} , j ) = A \to b ( {i}^{t} , j ) = 0$$

$$r \text{:} p x t$$

and the relation between the cycle r and the matrix size is given in Table 2-1.

TABLE 2-1

| Diffused Length p | | | | |
|---|---|---|---|---|
| 1 | 2 | 3 | 4 | 5 |

8 × 8 Matrix

| | | | | | |
|---|---|---|---|---|---|
| Cycle r | 16 | 48 | 48 | 224 | 240 |

10 × 10 Matrix

| | | | | | |
|---|---|---|---|---|---|
| Cycle r | 32 | 96 | 96 | 224 | 240 |

12 × 12 Matrix

| | | | | | |
|---|---|---|---|---|---|
| Cycle r | 32 | 96 | 96 | 224 | 480 |

14 × 14 Matrix

| | | | | | |
|---|---|---|---|---|---|
| Cycle r | 32 | 96 | 96 | 448 | 480 |

16 × 16 Matrix

| | | | | | |
|---|---|---|---|---|---|
| Cycle r | 32 | 96 | 96 | 448 | 480 |

If a matrix is not a square matrix, then such matrix is applicable for the square matrix with the largest number of rows or fields. For example, the 8×16 matrix is applicable for the 16×16 square matrix.

With the understanding of the foregoing diffusion method and matrix diffusion related definitions, the procedure taken in the present invention is described as follows:

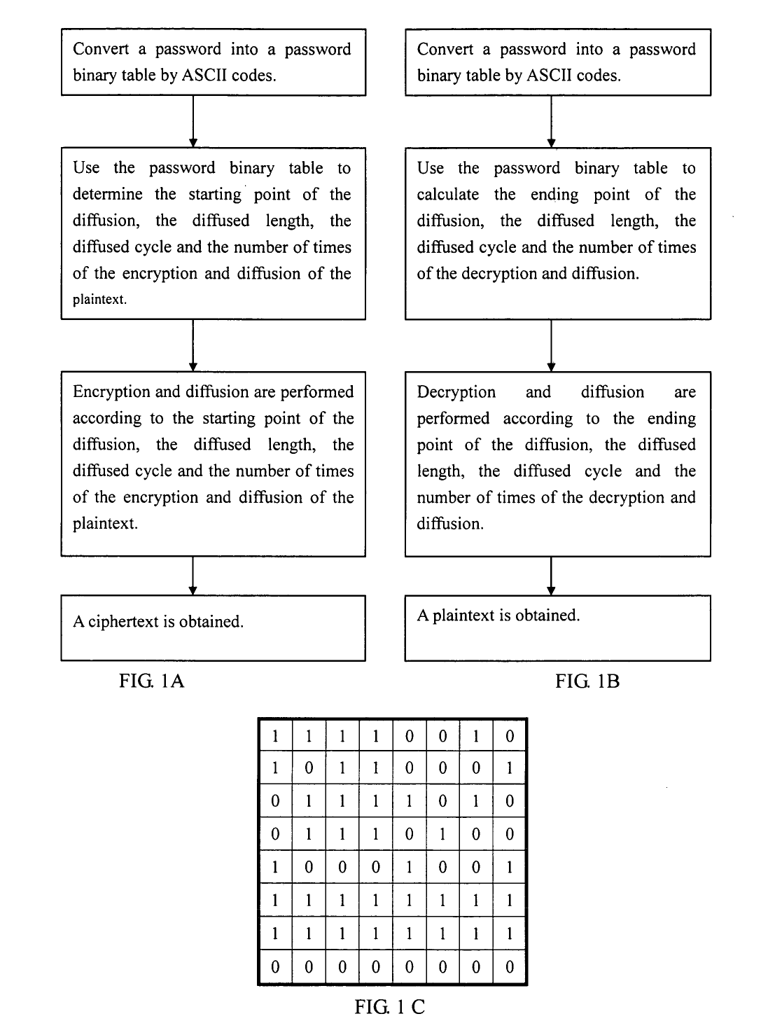

Please refer to FIG. 1A for the flow chart of an encryption according to the present invention, and its algorithm is described as follows:
1. Convert the plaintext and password into the plaintext binary table and the password binary table.
2. The n^{th} field of the plaintext is taken as the diffused field, where n=1˜8.
3. Use the value “1” of the n^{th} field in the password binary table as the starting point of the diffusion to carry out the encryption and diffusion in sequence, and the diffused length p is “1” and the number of times of the diffusion is (Cycle r/2)-1.

In the password binary table, the values in the 1^{st}, 4^{th}, 5^{th} and 7^{th} positions of the first field are all “1”s. Therefore, (1,1) in the plaintext binary table is used as the starting point for the diffusion and “1” as the diffused length p for carrying out the encryption and diffusion. The number of times for the encryption and diffusion is (cycle r)/2-1, which means 7 times for each. The plaintext binary table produced after using (1,1) as the starting point for the diffusion for carrying out the encryption and diffusion for 7 times. Points (1,4), (1,5) and (1,7) are used in sequence as starting points for the diffusion to carry out the encryption and diffusion. After the 1st field is encrypted and diffused, the 2nd field, the 3rd field, the 4th field and so forth of the plaintext binary table are encrypted and diffused in sequence to obtain the ciphertext as shown in Table 3-1:

TABLE 3-1

| | | | | | | | |
|---|---|---|---|---|---|---|---|
| 0 | 0 | 0 | 0 | 1 | 1 | 0 | 0 |
| 0 | 1 | 1 | 0 | 1 | 1 | 1 | 1 |
| 1 | 0 | 0 | 1 | 0 | 1 | 1 | 1 |
| 0 | 1 | 0 | 1 | 0 | 1 | 0 | 1 |
| 0 | 0 | 0 | 1 | 1 | 1 | 0 | 0 |
| 0 | 1 | 1 | 1 | 1 | 1 | 0 | 0 |
| 1 | 0 | 0 | 1 | 0 | 1 | 0 | 0 |
| 1 | 0 | 1 | 1 | 1 | 1 | 0 | 1 |

For the principle of the decryption, the feature of the cycle r is used for the matrix diffusion, and the value “1” of the n^{th} field in the password binary table is used as the starting point for the decryption and diffusion in a reverse sequence and the sum of the number of times of decryption and diffusion and the number of times of encryption is set to be the cycle r in order to decipher the ciphertext to the original plaintext. Its procedure is described in details by the following example:

Please refer to FIG. 1B for the flow chart of the decryption according to the present invention, and its algorithm is described as follows:
1. Convert the ciphertext and the password into the ciphertext binary table and the password binary table.
2. The n^{th} field of the ciphertext is taken as the diffused field, where n=8˜1.
3. Use the value “1” of the n^{th} field in the password binary table as the starting point of the diffusion to carry out the decryption and diffusion in reverse sequence, and the diffused length p is “1” and the number of times of the diffusion is (Cycle r/2)+1.

In the password binary table, the values in the 1^{st}, 2^{nd}, 5^{th}, 6^{th} and 7^{th} positions of the first field are all “1”s. Therefore, (8, 7) in the plaintext binary table is used as the starting point for the diffusion and “1” as the diffused length p for carrying out the decryption and diffusion. The number of times for the decryption and diffusion is (cycle r)/2+1, which means 9 times for each. Then, (8,6), (8,5), (8,2) and (8,1) are used as starting points for carrying out the decryption and diffusion. After the 8^{th} field is decrypted and diffused, the 7^{th}, 6^{th} and 5^{th} fields and so forth of the ciphertext binary table are decrypted and diffused to obtain the plaintext binary table and the original plaintext.

Please refer to FIG. 1C. If the plaintext and password are asymmetric square matrixes; for example, the plaintext is an 8×8 matrix and the password is a 4×4 matrix, then one area (as shown in the shaded gray area) corresponding to a password matrix is encrypted and diffused, and then diffused to the whole plaintext matrix for the encryption. Therefore, even the size of the password is smaller than the plaintext, the whole plaintext can be encrypted and the area corresponding to the password matrix can be change according to user's setup instead of being restricted to the upper left area of the figure. Further, the starting point of the diffusion for the encryption and decryption can be the value “0” at the n^{th} field of the password binary table. The values of the number of times for the encryption and diffusion and the number of times for the decryption and diffusion are used as examples for the illustration only, but not used as a limitation to certain specific values for the number of times for the encryption and diffusion and the number of times for the decryption and diffusion. As far as the sum of the number of times for the encryption and diffusion and the number of times for the decryption and diffusion is equal to the cycle r, then it will be fine, and such values are used for describing the present invention only, but not for limiting the scope of the claims of the invention.

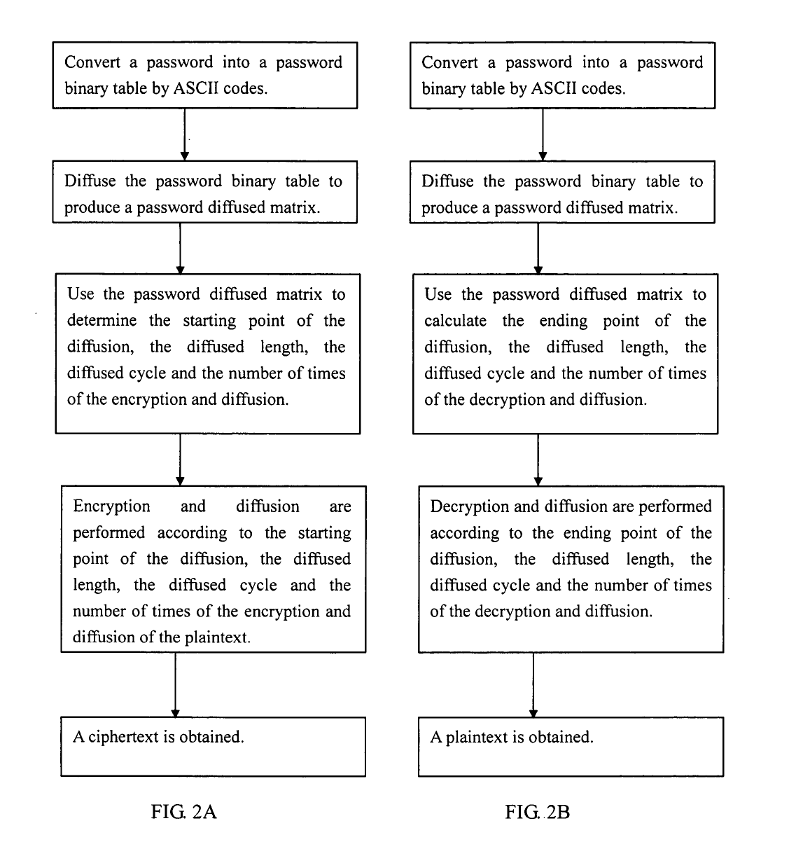

Please refer to FIG. 2A for the flow chart of another encryption according to the present invention, and its algorithm is given as follows:
1. Convert the plaintext and the password into the plaintextt binary table and the password binary table.
2. Get a value from the password binary table for performing the diffusion to produce a password diffusion matrix.
3. The n^{th} field of the plaintext is taken as the diffused field, where n=1˜8.
4. Use the n^{th} field in the password diffused matrix as the starting point of the diffusion to carry out the encryption and diffusion, and the diffused length p is >“1” and the number of times of the diffusion is equal to (Cycle r/2)-1.

The password binary table is diffused to produce a password diffused matrix, and either “1” or “0” the password diffused matrix having the most consecutive positions is used as the starting point for the diffusion, and the number of the consecutive positions are used as the diffused length p. The algorithm and description of such password diffused matrix are given below:

Initial conditions: A 4×4 matrix is produced, and the values of the password are filled into the matrix according to their positions, and “1” is filled in the field if no value is available.
1. The matrix is diffused from s in the position table (s=1˜16).
2. The values of the matrix are obtained from the position table in sequence (matching with the number of fields.)
3. If any value of the matrix is not available, then such value is updated to “1” according to the position table.

Each field of the password binary table is taken out in sequence, and a predetermined position table is filled into a matrix (such position table is shown in Table 3-2 or any other position table with different sequence), and the rest positions are filled with the value “1”. After the matrix is diffused from s=1 in the position table, the values matching the field size are taken out from the position table in sequence. If the condition of “1” or “0” having the most successive positions is not fulfilled, then the next field is computed; if the condition is still not fulfilled, then the matrix will be updated according to the position table. The position table is diffused from the next position “2”, and the aforementioned steps are repeated until the condition is fulfilled.

TABLE 3-2

| | | | |
|---|---|---|---|
| 16 | 2 | 3 | 13 |
| 5 | 11 | 10 | 8 |
| 9 | 7 | 6 | 12 |
| 4 | 14 | 15 | 1 |

In the foregoing example of taking “Y ourlips” as the password, the value of the password “10011010” is filled into the new matrix and the rest are filled with the value “1” as shown in Table 3-3.

TABLE 3-3

| | | | |
|---|---|---|---|
| 1 | 0 | 0 | 1 |
| 1 | 1 | 1 | 0 |
| 1 | 1 | 0 | 1 |
| 1 | 1 | 1 | 1 |

After Position 1(4,4) is used as the starting point for the diffusion, its values are listed in Table 3-4:

TABLE 3-4

| | | | |
|---|---|---|---|
| 0 | 1 | 0 | 1 |
| 1 | 1 | 1 | 1 |
| 1 | 0 | 0 | 0 |
| 0 | 0 | 0 | 0 |

The values taken out in sequence from s=1 to 8 of the position table is “01001001” but these do not fulfill the condition for “1” or “0” having the most successive positions. Therefore the matrix is updated according to the position table and diffused from s=2 of the position table. The aforementioned procedure is repeated until the values taken out from s=1 to 8 fulfills the condition for “1” or “0” having the most successive positions, and then the password diffusion is operated for the value of the password of the next field. The values of the password in all fields are diffused, and the password diffused matrix is shown in Table 3-5:

TABLE 3-5

| | | | | | | | |
|---|---|---|---|---|---|---|---|
| 1 | 0 | 0 | 1 | 1 | 1 | 1 | 0 |
| 1 | 1 | 0 | 0 | 0 | 1 | 1 | 0 |
| 1 | 1 | 1 | 0 | 1 | 1 | 0 | 0 |
| 0 | 0 | 1 | 1 | 0 | 1 | 1 | 1 |
| 0 | 0 | 1 | 1 | 0 | 0 | 1 | 1 |
| 0 | 1 | 0 | 1 | 1 | 0 | 1 | 1 |
| 0 | 1 | 0 | 1 | 1 | 0 | 1 | 1 |
| 0 | 1 | 1 | 1 | 1 | 1 | 1 | 1 |

According to the password diffused matrix of Table 3-5, the “1” or “0” of the password diffused matrix having the most successive positions is used as the starting point for the diffusion, and the successive number is used as the diffused length p as shown in Table 3-6:

TABLE 3-6

| | 1^{st} | 2^{nd} | 3^{rd} | 4^{th} | 5^{th} | 6^{th} | 7^{th} | 8^{th} |
|---|---|---|---|---|---|---|---|---|
| | Column | Column | Column | Column | Column | Column | Column | Column |
| Starting Point | 4 | 6 | 3 | 4 | 6 | 1 | 4 | 4 |
| for Diffusion | | | | | | | | |
| Diffused | 5 | 3 | 3 | 5 | 3 | 4 | 5 | 5 |
| Length p | | | | | | | | |
| Cycle r | 240 | 48 | 48 | 240 | 48 | 224 | 240 | 240 |

After the starting point for diffusion, diffused length p and cycle r for each field are obtained from the foregoing password, the plaintext binary table is encrypted and diffused. The encryption and diffusion described by the following example.

In the password diffused matrix, the starting point for the diffusion of the first field of the 2D plaintext matrix is 4 and the diffused length p is 5. Therefore, Points (1,4) (1,5) (1,6) (1,7) (1,8) are taken in sequence to produce the encryption and diffusion, The number of the times of the encryption is equal to (cycle r)/2-1, which is 119 times. After the first field is encrypted and diffused, then perform the encryption and diffusion for the 2^{nd} field, the 3^{rd} field, the 4^{th} field, and so forth to obtain the ciphertext as shown in Table 3-7 below:

TABLE 3-7

| | | | | | | | |
|---|---|---|---|---|---|---|---|
| 1 | 0 | 1 | 0 | 1 | 1 | 1 | 1 |
| 0 | 0 | 0 | 1 | 0 | 0 | 0 | 1 |
| 0 | 0 | 1 | 0 | 0 | 1 | 1 | 0 |
| 0 | 0 | 1 | 1 | 1 | 1 | 0 | 0 |
| 1 | 1 | 1 | 0 | 0 | 0 | 1 | 1 |
| 0 | 0 | 0 | 1 | 1 | 1 | 0 | 1 |
| 1 | 1 | 0 | 1 | 1 | 1 | 0 | 0 |
| 0 | 0 | 0 | 0 | 0 | 1 | 0 | 0 |

Similarly, the principle of decryption also uses the feature of the cycle r of the matrix diffusion to continue the diffusion from the next position of the last diffused point of each ciphertext field to make the sum of the number of times of decryption and diffusion and the number of times of encryption equal to the cycle r in order to obtain the original plaintext. Its procedure is described in details by the following example:

Please refer to FIG. 2B for the flow chart of a decryption according to the present invention, and its algorithm is given as follows:
1. Convert the ciphertext and the password into the ciphertext binary table and the password binary table.
2. The n^{th} field of the ciphertext is taken as the diffused field, where n=8˜1.
3. Use the n^{th} field in the password diffused matrix to carry out the decryption and diffusion from the next position of the last point of the encryption, and the number of times of the diffusion is equal to (Cycle r/2)+1.

If the user has the ciphertext and the password, then the password is computed similarly according to the foregoing computation to obtain the starting point of diffusion, diffused length p, cycle r and last point of encrypted diffusion for each field during the encryption, the ciphertext can be decrypted in the reverse sequence. In the password diffused matrix, since the starting point for diffusion of the 8^{th} field of the diffused ciphertext is (8,4) and the diffused length p is 5 and the number of times for encryption and diffusion is 119, the last point for the diffusion of the original encryption and diffusion is (8,7). Therefore, the starting point of the decryption is (8,8) and the number of times for decryption and diffusion is 121, and Points (8,8) (8,4) (8,5) (8,6) and (8,7) are decrypted and diffused in sequence for 121 times. After the decryption and diffusion for the 8^{th} field is completed, the 7^{th} field, 6^{th} field, the 5^{th} field and so forth of the ciphertext are decrypted and diffused in sequence to obtain the original plaintext.

The aforementioned first and second preferred embodiments can be used separately or jointly. The same plaintext is encrypted according to the password binary table of the first preferred embodiment, and then encrypted according to the password diffused matrix of the second preferred embodiment. For decryption, it only needs to reverse the procedure of the two preferred embodiments for the decryption to obtain the original plaintext. The method of simultaneously using both encryptions and diffusions provides a double protection mechanism to the ciphertext as to further improve the security of the ciphertext.

Further, this invention can apply the aforementioned principle of encryption and decryption to further process the encryption and decryption of the full text. A block size of the 8×8 matrix is taken for example and described as follows:

Electronic Code Book (ECB) Mode:

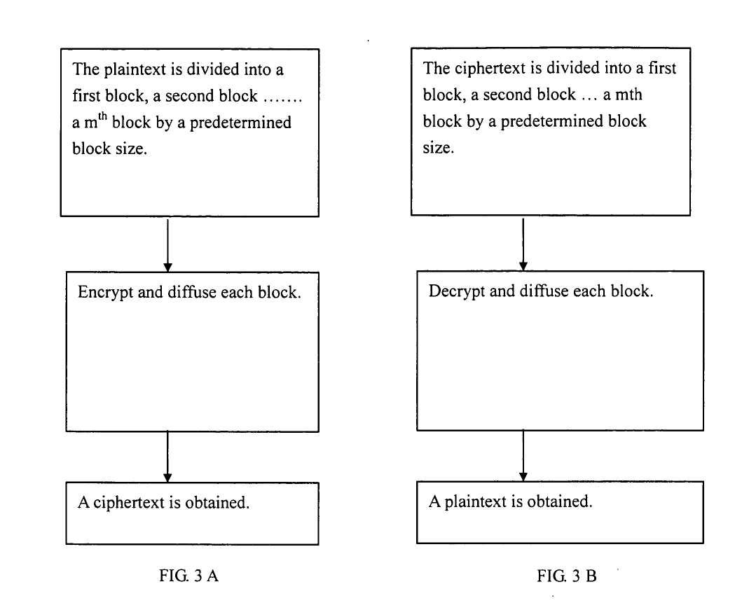

In FIG. 3A, if the number of bits of the plaintext is far larger than that of the password, the plaintext can be divided into a first plaintext block, a second plaintext block . . . a m^{th} plaintext block. For example, if the password has 64 bits and the plaintext has 192 bits, then the plaintext is divided by a first plaintext block, a second plaintext block and a third plaintext block, each having 64 bits, and each plaintext block is encrypted and diffused to obtain a first ciphertext, a second ciphertext and a third ciphertext and finally these three ciphertexts are combined into a full ciphertext of 192 bits.

Similarly, in the decryption and diffusion process as shown in FIG. 3B, the ciphertext of 192 bits is divided into a first ciphertext block, a second ciphertext block and a third ciphertext block each having 64 bits, and then each ciphertext block is encrypted and diffused by the password to obtain a first plaintext block, a second plaintext block and a third plaintext block, and these plaintext blocks combined into the original plaintext. Since the size of the plaintext is not a multiple of the predetermined size, therefore after the plaintext is divided by the predetermined size in sequence, insufficient blocks will be produced. Then, zeros can be filled to make up the last plaintext block to facilitate the encryption and decryption operations. Chain Block Coding (CBC) mode 1:

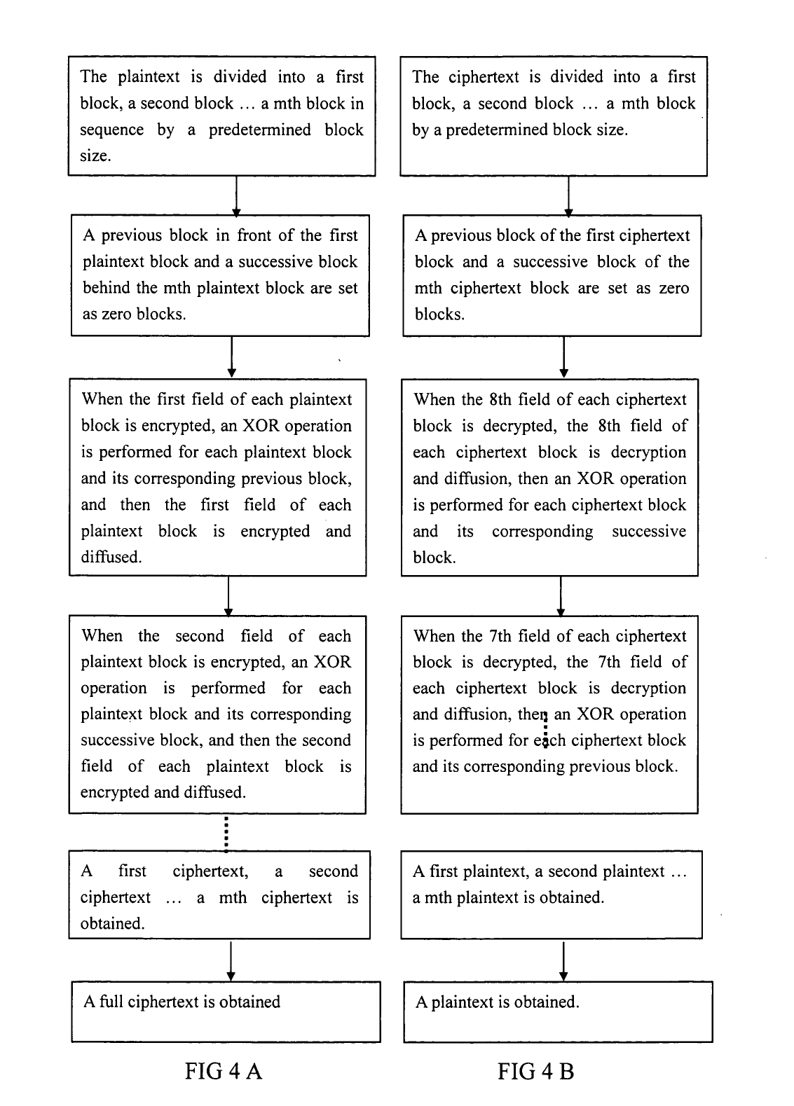

Please refer to FIG. 4A for another full text encryption and decryption according to the present invention. The plaintext of the full text is divided into a first plaintext block, a second plaintext block . . . a m^{th} plaintext block by a predetermined size, and the block in front of the first plaintext block is set to be a zero block (having zeros in the block), and block behind the m^{th} plaintext block is also set to be a zero block. Then, all the plaintext blocks are encrypted at the same time. When the first field is encrypted, an XOR operation is performed for each plaintext block and its previous block, and then the first field is diffused; and then the second field is encrypted, and an XOR operation is performed for each plaintext block and its successive block, and the second field is diffused, and so on. If the number of fields is odd and an XOR operation is performed for each block and its previous block, then the fields are diffused. If the number of fields is even and an XOR operation is performed for each block and its successive block, then the fields are diffused. After all fields are encrypted in sequence to obtain a first ciphertext, a second ciphertext . . . a m^{th} ciphertext and these ciphertexts are combined into a full ciphertext.

In FIG. 4B, if the full ciphertext is decrypted, the full ciphertext is divided into a first ciphertext, a second ciphertext . . . a m^{th} ciphertext by a predetermined size, and the block in front of the first ciphertext is set as the zero block and the block after the m^{th} ciphertext is also set as the zero block. All ciphertexts are decrypted at the same time. Firstly, after the 8^{th} fields of all ciphertext are decrypted and the 8^{th} field is diffused, an XOR operation is performed for each ciphertext and its successive block, and then the 7^{th} field is decrypted. After the 7^{th} field is diffused, an XOR operation is performed for each ciphertext and its previous block, and so forth.

If the number of fields is even and the fields are diffused, then an XOR operation is performed for each ciphertext and its successive block. If the number of fields is odd and the fields are diffused, then an XOR operation is performed for each ciphertext and its previous block. After all fields are decrypted in a reverse sequence to obtain a first plaintext, a second plaintext . . . a m^{th} plaintext and these plaintexts are combined into a full plaintext.

Chain Block Coding (CBC) Mode 2:

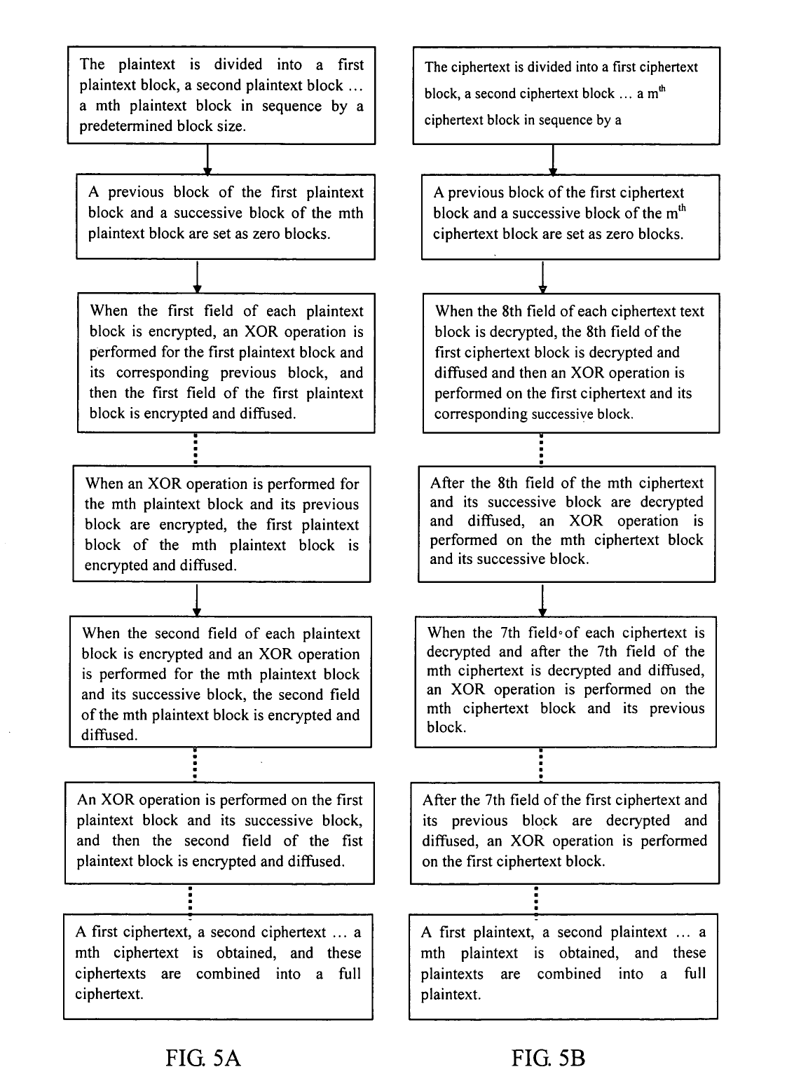

Please refer to FIG. 5A for a further full text encryption method according to the present invention. The full text of the plaintext is divided into a first plaintext block, a second plaintext block . . . a m^{th} plaintext block by a predetermined size first. The block in front of the first plaintext block is set to be a zero block and the block behind the m^{th} block is also set to be a zero block. Each block is encrypted in sequence. The first field is encrypted first, an XOR operation is performed for the first plaintext block and its previous block, and then the first field of the first plaintext block is diffused Similarly, the first field of the second plaintext block goes through the same procedure until the first field of the m^{th} plaintext block is processed. When the second field is encrypted and an XOR operation is performed for the m^{th} plaintext block and its successive block. The second field of the m^{th} plaintext block is diffused. Similarly, the second field of the m-1^{th} block goes through same procedure until the second field of the first plaintext block is processed, and so on. If the number of fields is odd, blocks in sequence, an XOR operation is performed for each plaintext block and its previous block, and then a particular field of a particular plaintext block is diffused. If the number of fields is even blocks in a reverse order, an XOR operation is performed for each plaintext block and its successive block, and then that particular field of that particular plaintext block is diffused. After all fields are encrypted in sequence to obtain a first ciphertext, a second ciphertext . . . a m^{th} ciphertext and these ciphertexts are combined into a full ciphertext.

In FIG. 5B, when the full text of the ciphertext is decrypted and diffused, the full ciphertext is divided into a first ciphertext, a second ciphertext . . . a m^{th} ciphertext by a predetermined size, and the block in front of the first ciphertext is set as the zero block and the block after the m^{th} ciphertext is also set as the zero block. Each ciphertext is decrypted in sequence. Firstly, after the 8^{th} fields of the first ciphertext is decrypted and the 8^{th} field of the first ciphertext is diffused, an XOR operation is performed for the first ciphertext and its successive block, and then the 8^{th} field of the second ciphertext goes through the same procedure until the 8^{th} field of the m^{th} ciphertext is decrypted. Then the 7^{th} field is decrypted and after the 7^{th} field of the m^{th} ciphertext is diffused, an XOR operation is performed for the m^{th} ciphertext and its previous block. The 7^{th} field of the m-1^{th} ciphertext is processed until the 7^{th} field of the first ciphertext is done, and so forth. If the number of fields is even and a field is taken out and diffused, then an XOR operation is performed for each ciphertext and its successive block. If the number of fields is odd and a ciphertext is taken out in reverse sequence and diffused, then an XOR operation is performed for that ciphertext and its previous block. After all fields are decrypted in a reverse sequence to obtain a first plaintext, a second plaintext . . . a m^{th} plaintext and these plaintexts are combined into a full plaintext.

Chain Block Coding (CBC) Mode 3:

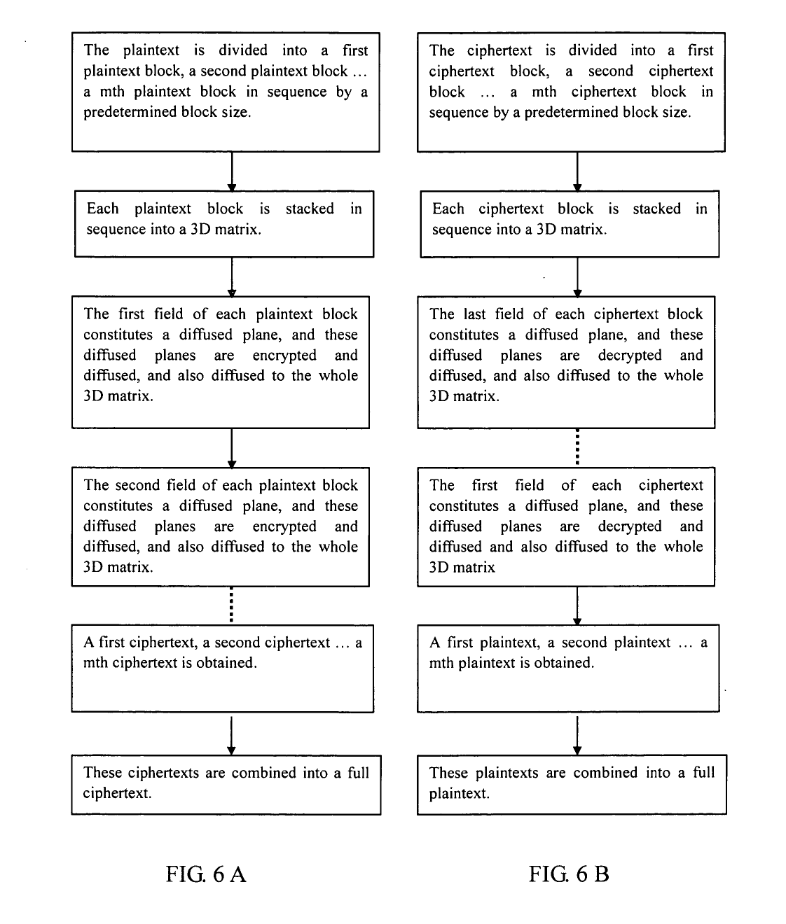

Please refer to FIG. 6A for another further full text encryption according to the present invention. The full text having a size of 512 bits is taken for example, and the plaintext is divided into a first plaintext block, a second plaintext block . . . a 8^{th} plaintext block by a predetermined size of 64 bits. All plaintext blocks are stacked into an 8×8×8 cubic matrix. If the size of the plaintext is not a multiple of the predetermined size, zeros will be filled to make up the cubic matrix. If the size exceeds the cubic matrix, an additional cubic matrix can be created. In the encryption of a plaintext, each field of each block constitutes each diffusion plane, and the source of the diffused points for such diffusion planes is determined by the password for performing a 3D diffusion on the cubic matrix. The first field of all blocks is taken out in sequence to form a diffused plane, and the first diffused plane is used as the source of the diffused point by means of the password for the encryption and diffusion. The diffusion is extended from the first diffused plane to the entire cubic matrix. After all fields from the first diffused plane to the eighth diffused plane are encrypted to obtain a first ciphertext, a second ciphertext . . . a m^{th} ciphertext and these ciphertexts are combined into a full ciphertext.

In FIG. 6B, if the full ciphertext is decrypted and diffused, the full ciphertext is divided into a first ciphertext, a second ciphertext . . . a m^{th} ciphertext by a predetermined size, and these ciphertexts are stacked to form a cubic matrix. Each field of the ciphertext constitutes each diffused plane, and each diffused plane is decrypted and diffused to the entire cube. All fields from the eighth diffused plane to the first diffused plane are decrypted in a reverse sequence to obtain a first plaintext block, a second plaintext block . . . a m^{th} plaintext block, and these plaintext blocks are combined to form a full plaintext.

The foregoing embodiment diffuses and encrypts all fields of each plaintext block to form a diffused plane for the 3-dimensional diffusion and encryption, or aims at a certain field or several fields in a plane for the diffusion and encryption, which can greatly expedite the encryption and decryption processes. The foregoing cubic encryption and decryption method can be applied to 4-dimensional or n-dimensional encryption and diffusion.

The key point of this invention resides on using the password as the source of the diffused point to perform an encryption or a decryption on the plaintext binary matrix, and the method for determining the source of the diffused point is not limited to the aforementioned method of using a specific value “0” or “1” as the diffused point or the value of successive “0”s or “1”s as the diffused point, but also can apply the matrix diffusion of the password binary table to obtain the center of gravity of the plane after the diffusion of the password binary table for each time as to form the non-successive diffused positions of the plaintext, and its procedure is described as follows:

$$Center of Gravity \text{:}$$

$$x = \overline{x} = \frac{{\sum }_{i ∈ S}^{} {n}_{i} {x}_{i}}{{\sum }_{i ∈ S}^{} {n}_{i}}$$

$$y = \overline{y} = \frac{{\sum }_{i ∈ S}^{} {n}_{i} {y}_{i}}{{\sum }_{i ∈ S}^{} {n}_{i}}$$

$${x}_{i} \text{:} Position of x , {n}_{i} \text{:} Number of 0 s or 1 s in that position$$

$${y}_{i} \text{:} Position of y , {n}_{i} \text{:} Number of 0 s or 1 s in that position$$

$$S \text{:} Diffused Plane$$

In the password binary table, the first quadrant represents that the center of gravity can be calculated as (4,4), and the plaintext position (4,4) is used as the diffused point for the diffusion. After the diffusion of the password table is repeated for several times, several diffused positions of the plaintext are determined. Since a non-continuous characteristic will occur at the center of gravity of the diffused matrix, therefore a non-continuous diffusion can be produced when the encryption and diffusion take place. The password can be diffused in the 2D diffusion or changed to a 3D diffusion, and then the 2D plane can be extended to find the center of gravity. The diffused point of the password can be determined by the position of a specific value or the position of the center of gravity.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A diffused data encryption/decryption processing method, comprising:
a plaintext; and
a password;
such that said password being used as a source of diffused points to perform an encryption and diffusion computation to said plaintext to produce a ciphertext and achieve the effect of encrypting said plaintext.

2. The diffused data encryption/decryption processing method of claim 1, wherein said decryption method comprises at least one ciphertext, and said password is used as a source of diffused points to decrypt and diffuse a binary matrix of said ciphertext and decipher said plaintext.

3. The diffused data encryption/decryption processing method of claim 1, wherein said plaintext is at least a 2D matrix.

4. The diffused data encryption/decryption processing method of claim 1, wherein said password is at least a 2D matrix.

5. The diffused data encryption/decryption processing method of claim 4, wherein said at least 2D password is a source of diffused points.

6. The diffused data encryption/decryption processing method of claim 4, wherein said at least 2D password produces a password diffused matrix after being diffused.

7. The diffused data encryption/decryption processing method of claim 6, wherein said password diffused matrix is a source of diffused points.

8. The diffused data encryption/decryption processing method of claim 1, wherein said password diffused point selectively use 0/1 as said starting point of diffusion.

9. The diffused data encryption/decryption processing method of claim 1, wherein said password diffused point uses a continuous value as said starting point of diffusion.

10. The diffused data encryption/decryption processing method of claim 9, wherein said password diffused point uses a length of continuous value as a diffused length.

11. The diffused data encryption/decryption processing method of claim 10, wherein said continuous value is one selected from the collection of 0 and 1.

12. The diffused data encryption/decryption processing method of claim 5, wherein said password diffused point is the center of gravity of said password.

13. The diffused data encryption/decryption processing method of claim 7, wherein said password diffused point is the center of gravity of the password diffused matrix.

14. The diffused data encryption/decryption processing method of claim 7, wherein said diffused cycle is the sum of the number of times of said password encryption and diffusion and the number of times of said decryption and diffusion.

15. The diffused data encryption/decryption processing method of claim 1, wherein said plaintext is divided into at least two plaintext blocks according to a predetermined block size, and said each password block is encrypted and diffused according to said password to produces a corresponding ciphertext, and said ciphertexts are combined to produce a full ciphertext and complete the encryption effect.

16. The diffused data encryption/decryption processing method of claim 15, wherein said full ciphertext is divided into at least two ciphertexts according to a predetermined size and said each ciphertext is decrypted and diffused according to said password to produce the corresponding plaintext block and said plaintext blocks are combined to form a full plaintext and complete the decryption effect.

17. The diffused data encryption/decryption processing method of claim 15, wherein said first plaintext block has a zero value block each in front of and behind said first plaintext block; if each of the odd numbered fields of said plaintext block is encrypted, an exclusive or (XOR) operation is performed with said each block and said previous block and then said fields are encrypted and diffused; and if each of the even numbered fields of said plaintext block is encrypted, an exclusive or (XOR) operation is performed with said each block and said successive block and then said fields are encrypted and diffused.

18. The diffused data encryption/decryption processing method of claim 17, wherein said each block performs an exclusive or (XOR) operation when the same field of each plaintext block is encrypted.

19. The diffused data encryption/decryption processing method of claim 17, wherein said each block performs an exclusive or (XOR) operation in sequence one by one when the same field of each plaintext block is encrypted.

20. The diffused data encryption/decryption processing method of claim 1, wherein said plaintext is divided into at least two plaintext blocks according to a predetermined block size, and said plaintext blocks are stacked in sequence, and said each plaintext block selects at least one field to form a diffused plane, and said diffused plane is encrypted and diffused according to said password, while diffusing to said full plaintext block to complete said encryption effect.
